(19) United States
(12) Patent Application Publication
(10) Pub. No.: US 2014/0025512 A1
(43) Pub. Date: Jan. 23, 2014

(54) VENDOR PORTAL AND METHOD OF FACILITATING ELECTRONIC COMMERCE OVER A NETWORK

(71) Applicant: VIVA TAGS PTY LTD, Docklands (AU)

(72) Inventors: Graeme Armstrong, Docklands (AU); Joshua David McKinney, Hawthorn East (AU); Jason Douglas Elliott, Thornbury (AU); Qerim Shahini, Moorabbin (AU); Igor Gorelik, Oakleigh (AU); Thushan Fernando, Gowanbrae (AU); Daniel Chambers, Mount Waverley (AU); Shweta Shah, Pascoe Vale (AU); Juan Elichirigoity, Camberwell (AU); Krishna Nadiminti, Carnegie (AU); Dmitry Kryuchkov, South Yarra (AU)

(73) Assignee: Viva Tags Pty Ltd, Docklands (AU)

(21) Appl. No.: 13/873,820

(22) Filed: Apr. 30, 2013

Related U.S. Application Data
(60) Provisional application No. 61/673,818, filed on Jul. 20, 2012.

(51) Int. Cl. G06Q 30/02

(52) U.S. Cl. CPC G06Q 30/0277
USPC 705/14.73

(57) ABSTRACT

A vendor portal for electronic commerce over a network is provided. The vendor portal comprises a vendor portal web site, a collection of preconfigured modules linked to the portal, and vendor tools to enable a vendor to compile a promotional offer or service by selecting and personalising one or more preconfigured modules. The vendor portal further comprises a unique identifier generator to generate and link a unique identifier to said promotional offer or service; wherein the portal is operable to cause the vendor compiled promotional offer or service to be displayed on a user interface of a customer's networked device when a customer uses their networked device to scan said unique identifier.

### CROSS-REFERENCE TO RELATED APPLICATIONS

This patent application claims the benefit of priority to U.S. Provisional Patent Application Ser. No. 61/673,818, entitled “A VENDOR PORTAL AND METHOD OF FACILITATING ELECTRONIC COMMERCE OVER A NETWORK,” filed on 20 Jul. 2012, which is hereby incorporated by reference herein in its entirety.

### TECHNICAL FIELD

Described are embodiments directed to a vendor portal for electronic commerce over a network and a method for facilitating electronic commerce over a network.

### BACKGROUND

Mobile barcode formats such as Denso's QR (quick-response) code serve as unique identifiers for a variety of purposes. For example a product may be labelled with a matrix code enabling a customer bearing a smartphone to read the code using the smartphone, and thereby to retrieve networked information concerning the product and/or to purchase the product.

In more recent times, mobile barcodes (often referred to as tags) storing URLs appear in magazines, on signs, buses, business cards, or other objects about which users might need information. Users possessing a smartphone equipped with the correct software scan the image of the code in order to display contact information, open a web page in the smartphone's browser, or perform a variety of other tasks depending on the data embedded in the matrix code.

Of the mobile barcode formats in use today, Denso's QR Codes are the most widely used and recognisable. Their open source licencing has seen several free code generation services developed, allowing Vendors to quickly and easily generate basic QR Codes. However this open source environment is inherently risky when it comes to code integrity, with hacking of codes already emerging as a threat to the standard. Other tag formats such as Microsoft Tag are far more secure given their intermediary validation service which secures the tags' authenticity. However, because tags have rarely been used in conjunction with higher risk transactional functionality, Vendors generally opt for the broad recognition of QR over the security provided by these alternative formats.

When tags are generated using the QR format, the intricacy and size of the tag varies proportionately to the amount of data, typically the more combined data utilised, the larger the image has to be for an application to scan it. This is particularly problematic where publishing space is limited, such as in newspaper column advertisements.

When developing a solution for a particular vendor the different types of tags can cause problems. Moreover, different vendors vend different products or services to customers and some vendors have different requirements than other vendors.

### SUMMARY

A vendor portal for electronic commerce over a network, the vendor portal comprising:
a vendor portal web site and a collection of preconfigured modules linked to the portal, and vendor tools to enable a vendor to compile a promotional offer or service by selecting and personalising one or more preconfigured modules; and
a unique identifier generator to generate and link a unique identifier to said promotional offer or service; wherein the portal is operable to cause the vendor compiled promotional offer or service to be displayed on a user interface of a customer's networked device when a customer uses their networked device to scan said unique identifier.

The vendor portal may be further operable to cause each of the selected preconfigured modules to appear on the user interface as discrete items.

The vendor tools may further enable a vendor to selectively compile a single function promotional offering or service or a multi-function promotional offering and/or service.

The vendor tools may further enable a vendor to associate a landing page with a multi-function promotional offering and/or service. Preferably the landing page is configured to display a header associated with each of the selected and personalised preconfigured modules together with a theme related to the multi-function promotional offering and/or service.

The vendor portal web site may include a registration webpage to enable a vendor to register with the vendor portal.

Preconfigured modules may include one or more of content modules, lead generation modules, custom modules, transactions, in-store modules and associated products. Content modules may include one or more of external web links, play video, maps, get software application and Mobile Web Pages. Interactive modules may include one or more of dialler, emails, competitions, check in/opt in, reminders, and vCards. Transactions may include one or more of purchases, payments, timing, voting and coupons. In-store modules may include one or more of product info, a wish list, a loyalty, warranty and WiFi access. Associated products may include products from 3^{rd} party vendors.

A method for facilitating electronic commerce over a network, the method comprising:
compiling a promotional offer or service by selecting one or more preconfigured modules to be associated with the promotional offer or service;
generating a unique data identifier and linking the unique data identifier to the promotional offer or service;
causing the compiled promotional offer or service to be displayed on a user interface of a customer's networked device when a customer uses their networked device to scan the unique data identifier, wherein each of the selected preconfigured modules appear on the user interface of the customer's device as discrete items.

The method may further comprise selectively compiling a single function promotional offering or service or a multi-function promotional offering and/or service.

The method may further comprise generating a landing page to be associated with a multi-function promotional offering and/or service. The method may include configuring the landing page to initially display on a user interface of a customer's device when the customer uses their networked device to scan the unique data identifier, the landing page comprising a header associated with each of the selected and personalised preconfigured modules. The method may further include configuring the landing page to include a theme related to the multi-function promotional offering and/or service. The method may further include defining at least one of visual and functional elements that will appear on the landing page.

The vendor portal web site may include a registration webpage to enable a vendor to register with the vendor portal.

The method may further comprise uploading one or more images associated with the promotional offering or service.

The method may further comprise defining an effective start date which determines when the promotional offering or service will present fully when a customer uses their networked device to scan the unique identifier and an effective end date which determines when the promotional offering or service is to expire.

Other embodiments relate to a software application to be run on a user's networked device.

### BRIEF DESCRIPTION OF THE DRAWINGS

FIG. 1A is a schematic diagram illustrating a high level overview of the system architecture 100 which the present invention utilizes;

FIG. 1B is a block diagram illustrating an exemplary mobile e-Commerce platform in accordance with an embodiment of the invention;

FIG. 2 is a screenshot of a Vendor registration page of the Via Tags website which Vendors need to do to access to the mobile e-Commerce platform shown in FIG. 1b;

FIG. 3 is a screenshot of a Vendors tab on the Viva Tags Back Office website;

FIG. 4 is a screenshot of a User detail webpage which the Back Office administrator accesses from the Vendors tab shown in FIG. 3;

FIG. 5 is a screenshot of a MyDetails webpage which the Vendor accesses from the Via Tags Vendor portal;

FIG. 6 is a screenshot of a Fees webpage which the Vendor accesses from the Fees and Payment tab shown in FIG. 5;

FIG. 7 is a screenshot of a Default Fees webpage which the Back Office administrator accesses from the Vendors tab shown in FIG. 3;

FIG. 8 is a screenshot of a My Offerings webpage which the Vendor accesses from the Via Tags website;

FIG. 9 is a screenshot of an administrative form associated with the My Offerings webpage of FIG. 8;

FIG. 10A is a screenshot of a Landing Page Display associated with the My Offerings webpage of FIG. 8;

FIG. 10B is a screenshot of a mobile landing page preview associated with the present invention;

FIG. 11 is a screenshot of a Customer Action Display section associated with the My Offerings webpage of FIG. 8;

FIG. 12 is a screenshot of a Tags section associated with the My Offerings webpage of FIG. 8;

FIG. 13 is a screenshot of a Change Tags section associated with the My Offerings webpage of FIG. 8;

FIG. 14 is a screenshot of a Customer Actions webpage which the Vendor accesses from the My Offerings tab shown in FIG. 5;

FIG. 15 is a is a screenshot of an external web link attribute offered via the Customer Actions webpage of FIG. 14;

FIG. 16 is a screenshot of a video attribute offered via the Customer Actions webpage of FIG. 14;

FIG. 16a is a screenshot of a Mapping attribute offered via the Customer Actions webpage of FIG. 14;

FIG. 16b is a screenshot of a vCard attribute offered via the Customer Actions webpage of FIG. 14;

FIG. 16c is a screenshot of a Dialler attribute offered via the Customer Actions webpage of FIG. 14;

FIG. 17a is a screenshot of an Email enquiry attribute offered via the Customer Actions webpage of FIG. 15;

FIG. 17b is a screenshot of the software application that a Customer sees resulting from the email enquiry attribute of FIG. 17a;

FIG. 18a is a screenshot of a “Competition” attribute offered via the Customer Actions webpage of FIG. 15;

FIG. 18b is a screenshot of the software application that a Customer sees resulting from the “Competition” attribute of FIG. 18a;

FIG. 18c is a screenshot of a “Get App” enquiry attribute offered via the Customer Actions webpage of FIG. 15;

FIG. 18d is a screenshot of the software application that a Customer sees resulting from the “Get App” enquiry attribute of FIG. 18c;

FIG. 19a is a screenshot of an Unbilled Charges tab on the My Reports webpage which the Vendor accesses from the Via Tags website;

FIG. 19b is a screenshot of an Invoices tab on the My Reports webpage which the Vendor accesses from the Via Tags website;

FIG. 19c is a screen shot of a Back Office administrative invoicing webpage;

FIG. 20 is a screenshot of the Viva Tagsmobile application homepage;

FIG. 21 is a screenshot of a registration user interface of the mobile application referred to in FIG. 20;

FIG. 22 is a screenshot of a Customer registration website page, which the Customer needs to do to access the mobile e-Commerce platform shown in FIG. 1b;

FIG. 23 is a screenshot of a further user interface of the software application referred to in FIG. 20;

FIG. 24 is a screenshot of the Customer eWallet website page associated with the present invention;

FIG. 25 illustrates the flow methodology for a customer to access a Tag using their mobile device; and

FIG. 26 is a block diagram illustrating exemplary payment system architecture.

### DETAILED DESCRIPTION

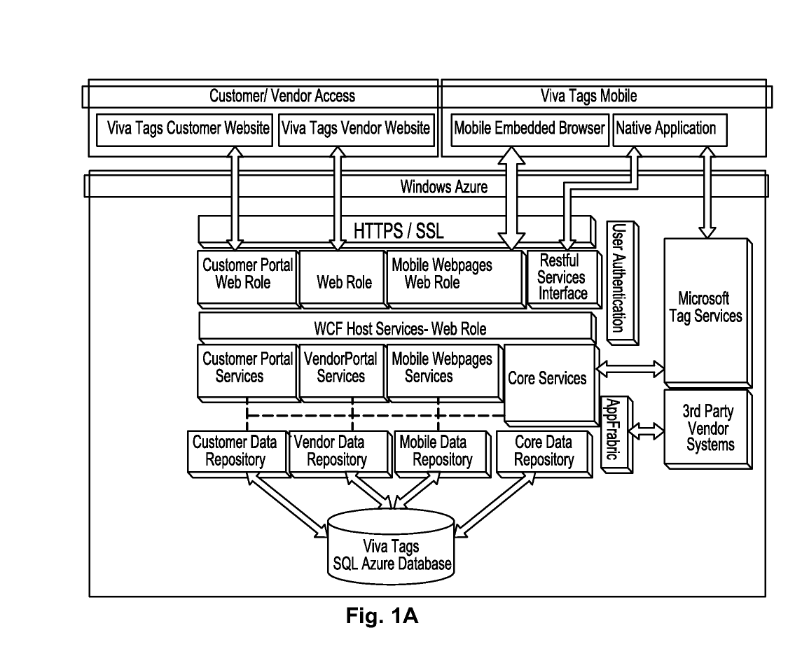

The present invention utilizes an integrated system architecture which is developed as a cloud based SAAS model and architecture. A high level overview of the system architecture 100 is illustrated in FIG. 1A.

Referring to FIG. 1B, a block diagram of the mobile e-commerce platform 150 for facilitating transactions between vendors and customers is illustrated. The platform may comprise a server cluster, or one or more server computers. Alternatively the platform may be implemented on a distributed server system. In any case, the platform may be implemented in a variety of different hardware environments, employing one or more server computers, each of which may comprise one or more microprocessors. Preferably, the platform is implemented principally via a ‘cloud computing’ platform, which advantageously enables a high level of scalability, which enabling the operator to avoid purchasing the significant dedicated resources necessary to handle peak loads. As such, the specific embodiments described herein, are exemplary only, and not limiting of the scope of the invention.

As shown in FIG. 1b, vendors are able to access the Vendor Web Portal 152 where Vendors register 154, create single function or multi function Offerings 156 from which are generated smart response tags 158 and to each of which are added a Landing page 160. Further, one or more Customer Action Modules 162 may be added to the Landing page 160.

Prospective customers are able to access the Customer Web Portal 170 either directly via the Customer Portal website or via Smartphone Apps 172 and/or Mobile Web Apps 174 using mobile devices such as GSM cellular mobile telephone or smart phones. Messages may be sent from the platform to the mobile devices using the mobile telephone network and particularly through any service provider to which the customer happens to subscribe. Further details of the implementation and operation of various embodiments of the platform will now be described with reference to accompanying drawings 2 to 25.

### Back Office-Fee Maintenance

Vendors are charged for use of the platform based on the following;
Vendor actions, such as creating an Offering or generating a Tag
Customer actions, such as Purchases, Payment, or submitting an Email Enquiry
Optional services, such as our full service Offering creation or training

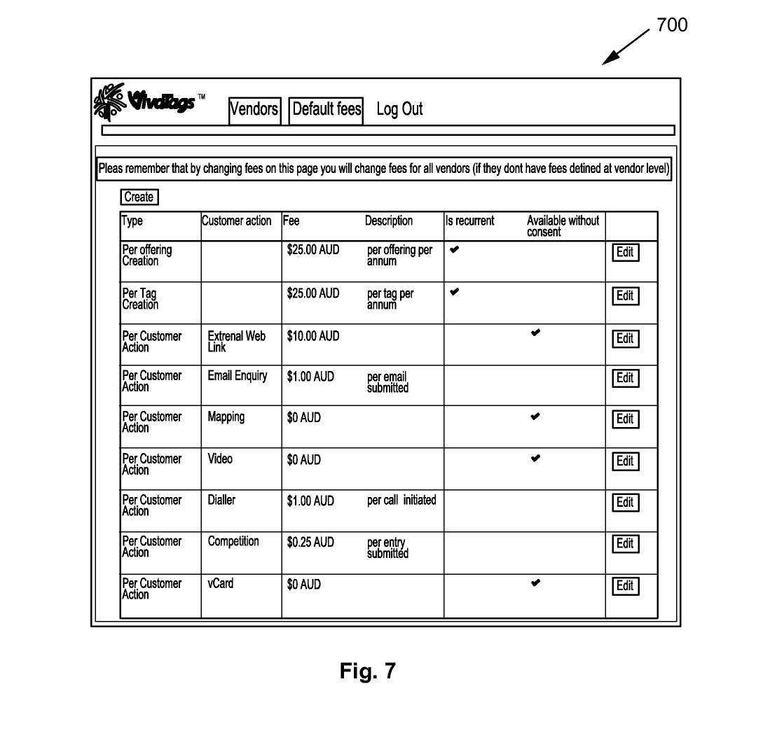

Back Office Administrator creates and maintains the default fees (see FIG. 7), some of which are recurring annually, via the back office system.

Customer Action modules that incur a fee to the vendor, such as a product purchase, are only available to the vendor after they have entered a valid card against which the fee can be charged. Whilst vendor actions, such as creating an offering, also incur a fee, these are made available without a supporting card. In part this is so we can offer the first few for free in which case no charges apply,and also because we want the Vendor to explore the platform without the concern of having to enter their card details prior to doing so. Should a vendor exceed any free trial offer, their account can be suspended until card details are provided.

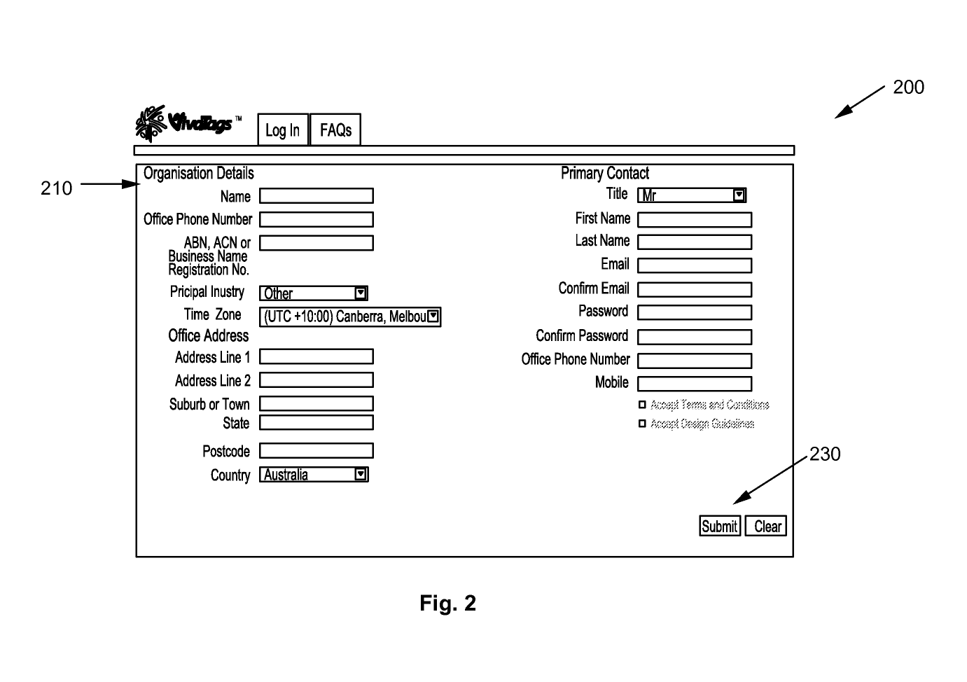

The Back Office Administrator also creates and maintains vendor specific fees via the back office system accessible via a separate webpage. The vendor specific fees override the Default Fees and are maintained via the vendor tab (see 320, FIG. 3), and can be applied to all or specific Offerings. This feature can also override the default settings by making Customer Action modules available to a particular Vendor without that Vendor having provided credit card details.

### Vendor Portal-Vendor Registration

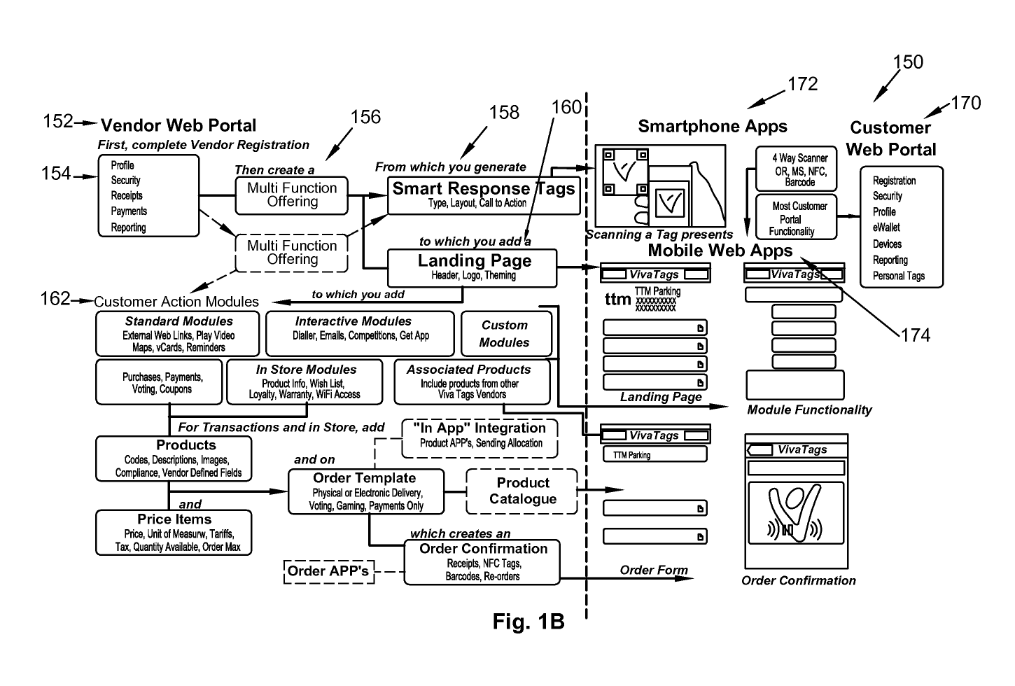

FIG. 2 illustrates a Vendor registration webpage 200 from the Viva Tags website. Vendors must register to be able to access the Viva Tags platform. The generic registration form 200 captures basic vendor organisational details 210 (name, phone number, company name etc) as well as establishes the profile of the first vendor user (primary contact) 220, who is required to accept vendor Terms and Conditions and Design Guidelines on behalf of the vendor. Submitting the form 230 presents an acknowledgement web page message to the vendor user, and triggers an email notification to the Viva Tags Back Office Administrator.

### Back Office-Vendor Approval

Upon receiving the Registration notification, a Viva Tags Back Office Administrator, or sales team member, is required to contact the vendor user, confirm their credentials, and establish their requirements for using the platform. This will subsequently inform which Order Form Templates they are given access to, which controls somewhat the possibility of a rogue Vendor creating bogus offerings for unrelated activities.

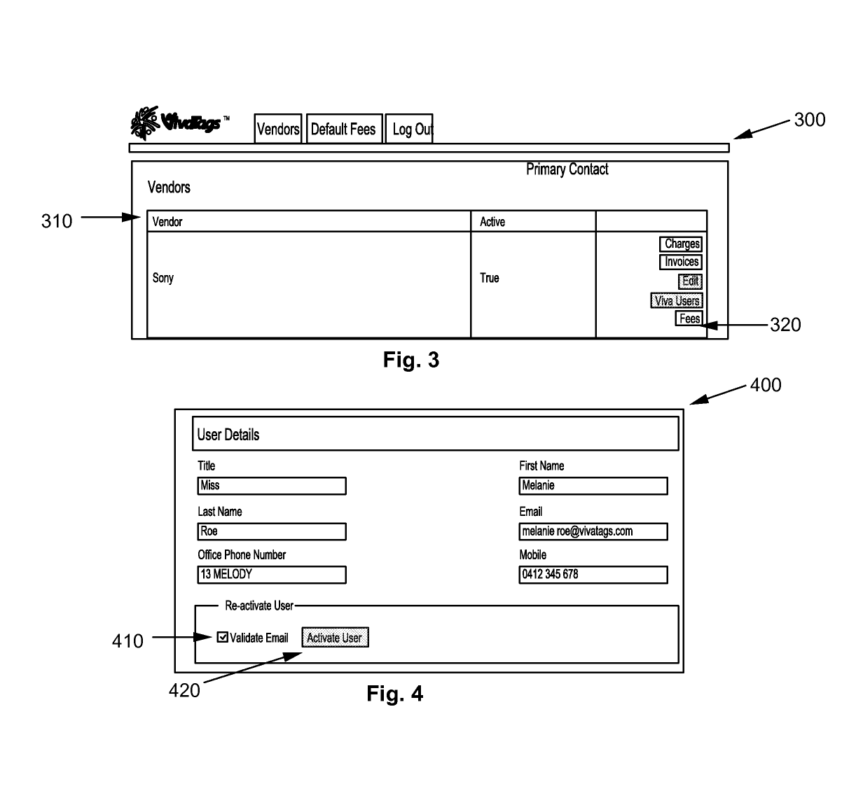

Once the Back Office Administrator or sales team member is satisfied that the vendor user is legitimate, the Back Office Administrator or sales team member logs in to the back office system from where they navigate the system website to the vendors tab 300 as illustrated in FIG. 3. The vendors tab 300 enables the Back Office Administrator or sales team member to control vendor portal access at both the organisational and user levels. Accessing a particular vendor 310 retrieves user detail webpage shown in FIG. 4. New vendor organisations are automatically set to “approved” 410 however the Back Office Administrator or sales team member vendor must activate the user by selecting the activate user field 420.

The Back Office Administrator can also create additional vendor users via the back office system, including an impersonation role which allows the Back Office Administrator to enter the vendor portal and perform functions as if they are a vendor user. This is most commonly required for conducting full service activities such as creating offerings on behalf of the vendor.

The Back Office Administrator can suspend a vendor organisation as a whole or individual vendor users, at any time via the back office system. This prohibits Vendor Users from logging into the platform until they are reactivated. This provides further security against actual or potential illegitimate Vendor activities. Activating the vendor user 420 triggers a final validation email to further ensure the authenticity of the vendor user credentials. Once the Vendor user clicks the validation link, the vender user is automatically activated and notified of full access to their vendor portal via a web page and email confirmation.

### Vendor Portal-My Details

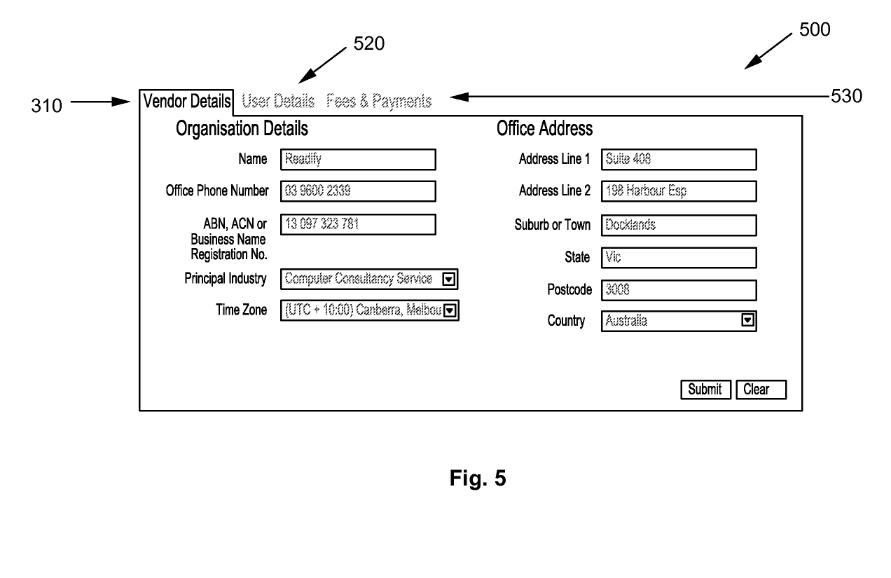

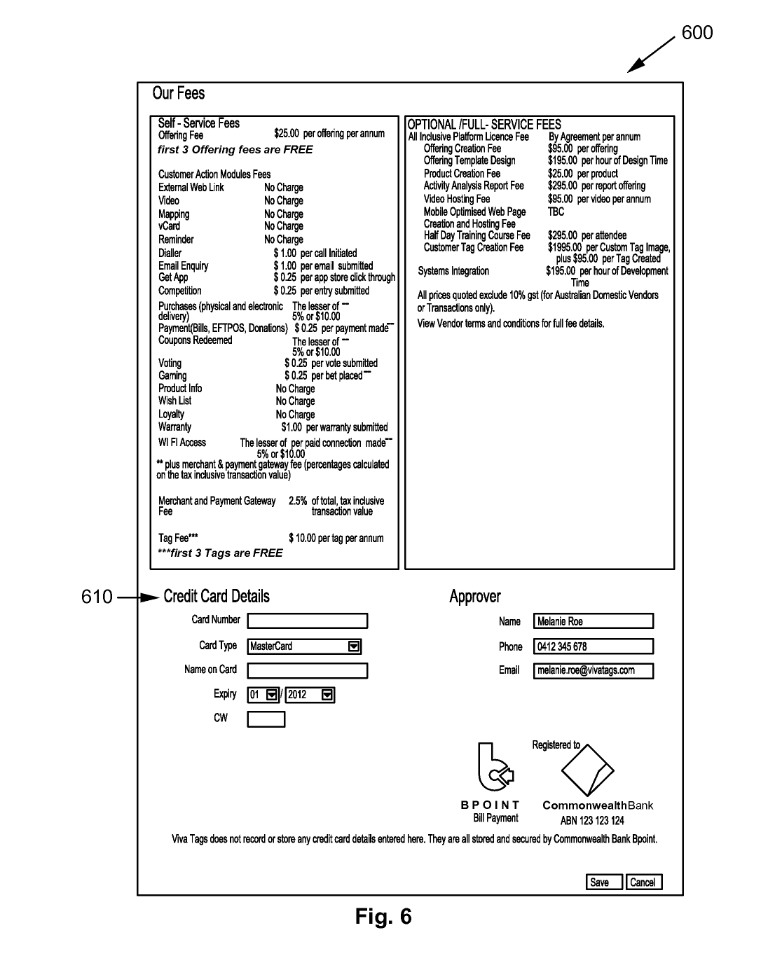

A vendor, having logged into the Vendor Portal of the website, is presented with a MyDetails webpage 500 as shown in FIG. 5. The MyDetails webpage 500 has three tabs; a Vendor Details tab 510 and a User Details tab 520 each allow the Vendor user to maintain the information provided with the original registration. The Fees and Payment tab 530 presents the fees 600 applicable for that vendor (see FIG. 6), as well as the payment gateway plug in 610 where the vendor user enters the vendor's credit or debit card for charging the vendor fees incurred.

Credit and Debit Card entry, maintenance, and security are managed via a plug in component provided by the payment gateway provider. This means that the system never stores any vendor card details within the system. Rather the payment gateway provider supplies a token which is passed back with any subsequent card charges.

### Vendor Portal-My Offerings/Multi Function Offerings

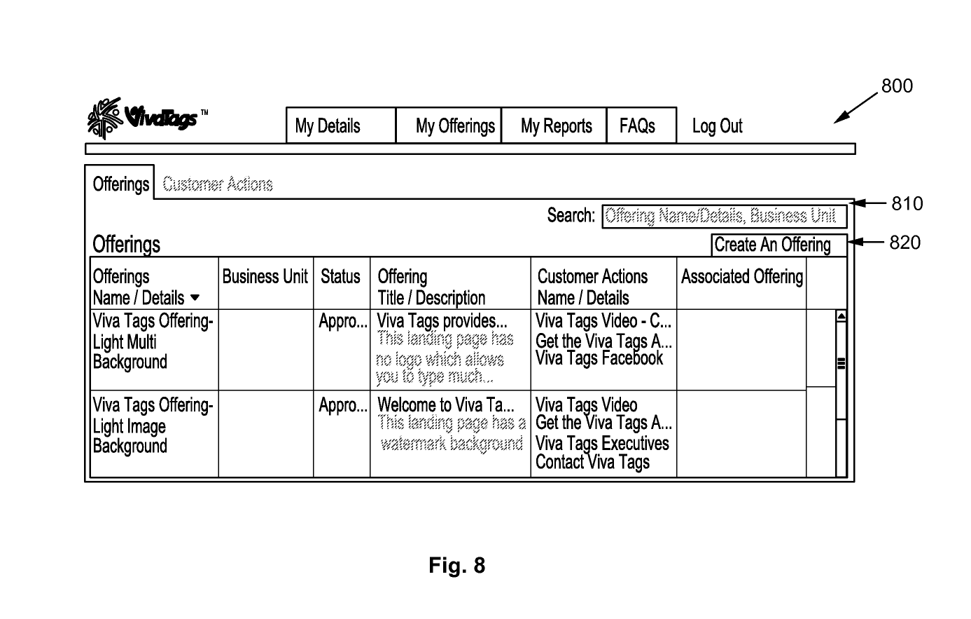

FIGS. 8 to 18d show screen shots of webpages from the Viva Tags website which the vendor user steps through in order to create/edit offerings.

FIG. 8 illustrates a screen shot of a webpage from the My Offering list view 800 which the vendor user accesses in order to create an offering. In this example, the vendor user has already created several Offerings. The Offering list view 800, like all of the list views, has filtering and search functionality 810, along with sort capability on each column header to assist the vendor user in locating Offerings. The key elements of each existing Offering are presented for easy identification and selection. Clicking the in line edit button opens an existing Offering. Meanwhile, new Offerings are able to be created 830.

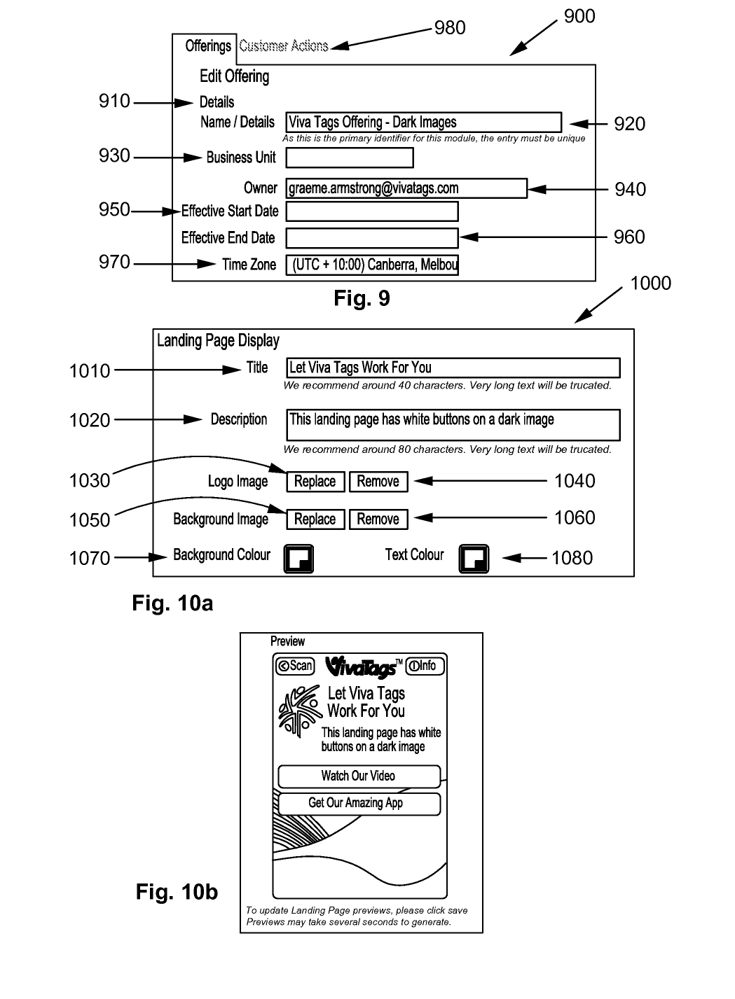

It is from within the Offering form that vendors define the visual and functional elements that their Customers ultimately experience when they scan an associated Tag. The associated Tag is also generated from within the Offering form. When the vendor user selects Create an Offering 830 they are presented with an Offering Form. FIG. 9 illustrates a screen shot of a first webpage 900 of the Offering form. The top Details section 910 of the Offering form deals with the administrative properties of the Offering. The Name/Details free text field 920 is the primary identifier for an Offering, and therefore it needs to be unique. The Business Unit 930 is an optional free text field for additional sorting. The Offering Owner 940 defaults to the vendor user however this can be changed should the user be creating the Offering on behalf of a third party, for example an advertising agency.

The field Effective Start Date field 950 determines when an Offering will present fully upon a Customer scan, prior to which a blank form message presents that the Offering is not yet current. The blank form is intended to hide any potentially sensitive information the Offering may contain or support. The Effective End Date field 960 determines when the Offering expires, following which a message, advising accordingly, presents on the Offering Landing Page without Customer Action buttons. Effective dates are calculated based on data selected in the time zone field 970.

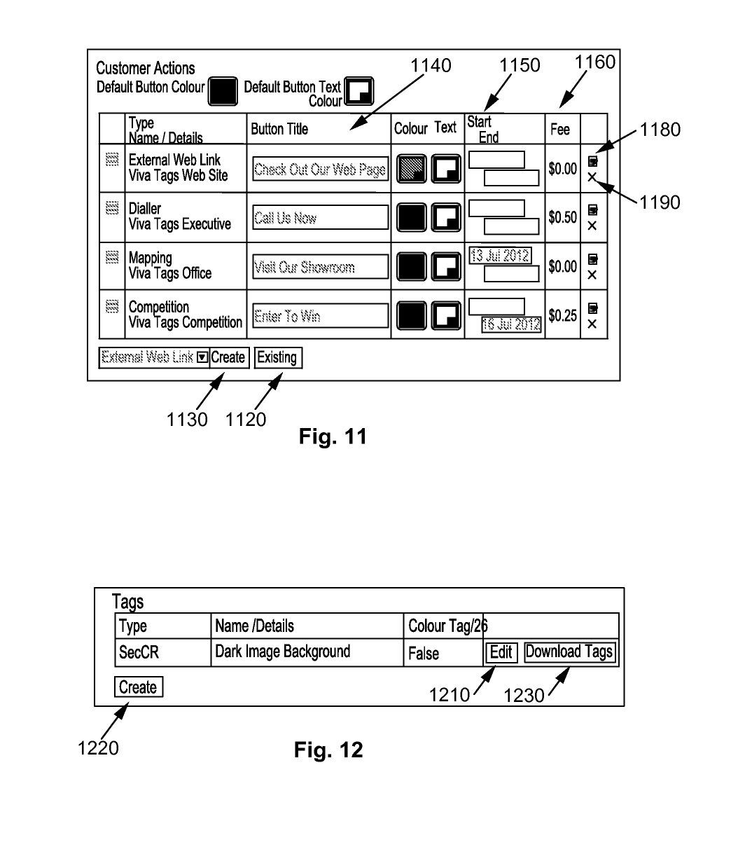

The Landing Pages Display illustrated in FIG. 10a is a subsequent webpage of the Offering form. As the name suggests, the Landing Pages Display 1000 determines the properties of the first page a Customer sees after they scan the vendor's Tag. The “Title” field 1010 content presents as the larger text that appears at the top of the Landing Page, which is followed by the smaller “Description” text content entered into the Description field 1020. Both are free text fields to provide the maximum flexibility and independence of the Offering. Provisions are in place to enable the vendor user to Add, Replace 1030 or Remove 1040 a Logo Image and similarly Add, Replace 1050 or Remove 1060 a Background Image. The logo image ultimately appears in the top left hand corner of the Landing Page whereas the background image covers the entire Landing Page. Both the logo image and the background are dynamically resized depending on their dimensions and that of the form factor. The background colour applies where a background image isn't used and the vendor user is able to select a Background Colour 1070. The vendor user is also able to select the text colour 1080 which applies to the Title and Description text. Saving the Offering (not shown) updates the Landing Page preview image 10b, which includes the Customer Actions buttons, and is the resultant first page that a Customer sees after they scan the vendor's Tag.

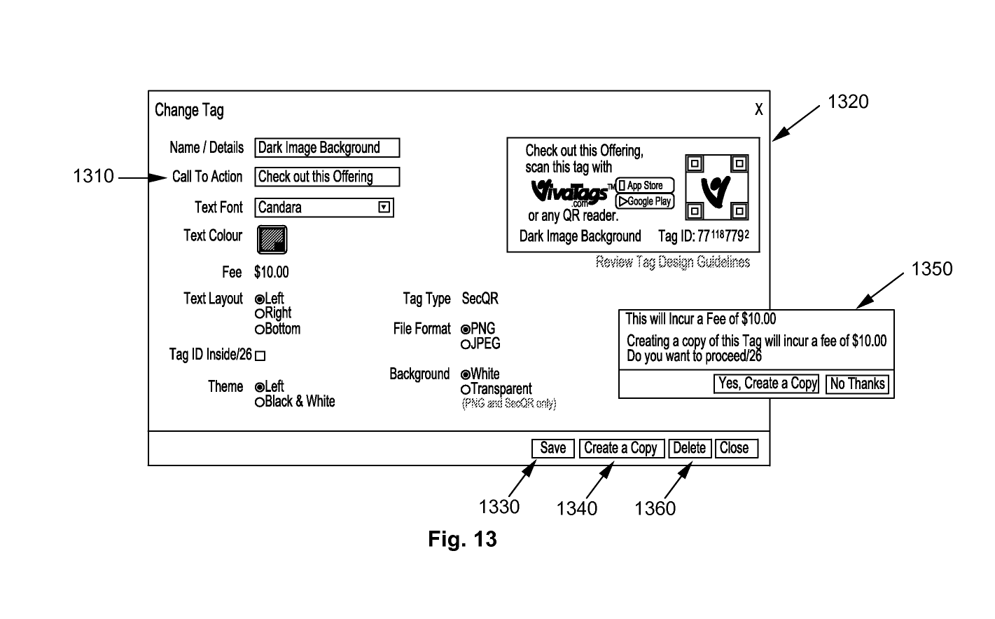

The Customer Action Display section of the Offering form which is illustrated in FIG. 11 defines which Customer Action modules appear on the Offering and in what order, as determined by dragging the left side handler. Customer Actions are added to the Offering by selecting the required type from a drop down box at the bottom of the section and clicking the “add existing” 1120 or “create” 1130 buttons. The top line selection options define the default Customer Action button properties as they appear on the Landing page, of which the button and text colours can be changed per Customer Action module inline below.

The list view also presents the selected Customer Action type and primary identifier (see Customer Action modules below) as well as the User defined landing page button title 1140. The Start dates field and End dates field 1150 provides additional security and flexibility around how the Offering may transform overtime by determining when individual Customer Action's appear on the Offering. The Fees column 1160 reconfirms the resulting fees per Customer action whilst the edit button 1180 and remove button 1190 relate to how the Customer Action appears on or in association with this Offering. The “add existing” 1120 pop up list view presents only the Customer Action type selected and provides the option to view only reusable or all matching Customer Actions.

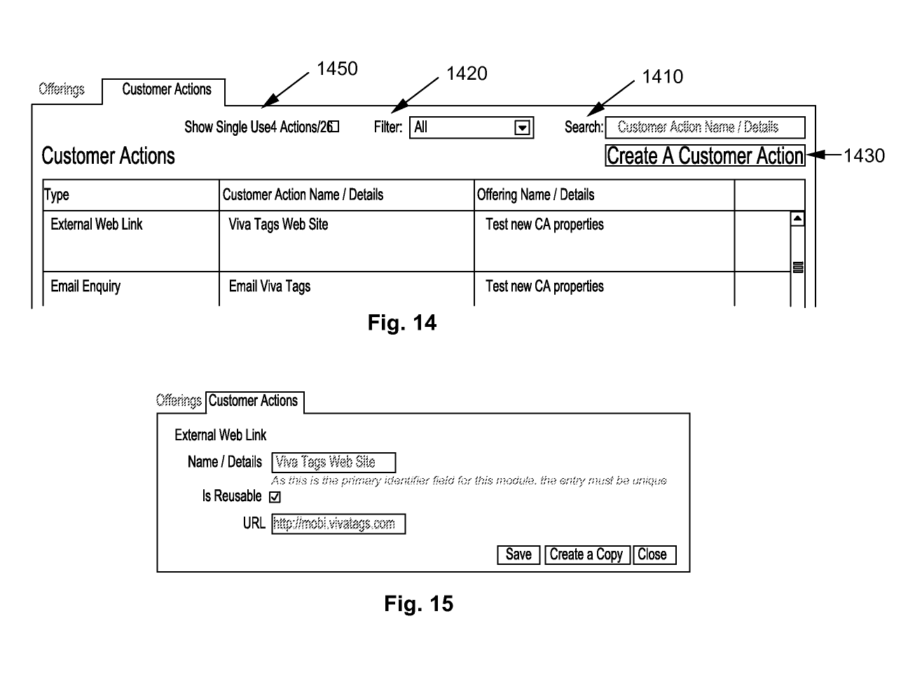

FIG. 12 illustrates the Tags section of the Offering form. This Tags section present a list view of all unique Tags created for a particular Offering, from which vendors can edit 1210 the Tag or download 1230 the Tag in line.

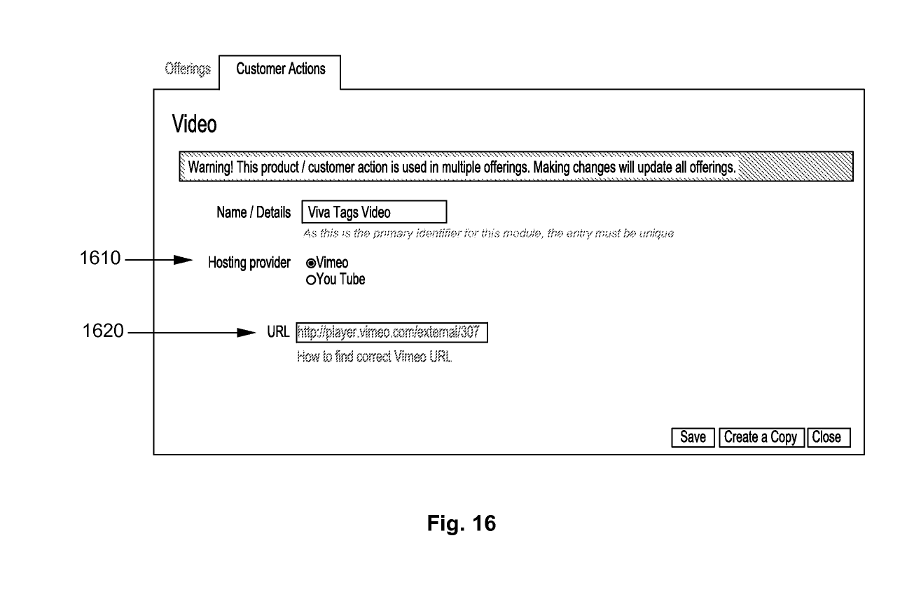

Creating a Tag 1220 or editing a Tag 1210 presents the Tag form, which not only generates the tag itself, but the most print ready tag copy possible. This is achieved by providing the User with several input and output options as illustrated in the Change Tag section of the Offerings Form (see FIG. 13). Like Offerings and Customer Actions, the Tags' unique identifier Name/Details field does not appear on the output copy. However the optional “Call To Action” field 1310 does, which if used is combined with the static “scan this tag with Viva Tags” copy 1320. The text colour and font properties are designed to match as closely as possible the associated print copy or corporate standards.

The Tag image is produced with crop marks for easy adherence to border space requirements whilst the option exists to include the Tag ID within the Tag image area, otherwise it appears outside where the Name/Details also appears. Saving 1330 a new tag or copying 1340 an existing one will always prompt the User to accept the Tag Generation fee 1350.

Copying an existing Offering creates an entirely new and independent Offering except for the associated Customer Actions, which are automatically converted to re-usable as a result of being associated with more than one Offering (see Customer Actions modules below). Deleting an Offering deletes all associates Tags and Non-reusable Customer Actions.

### Vendor Portal-My Offerings/Customer Actions

The Customer Action modules are a suite of distinct, vendor customisable, functionality which make up the options a Customer can select within an Offering. Table 1 illustrates the four main groups of functionality:

TABLE 1
Customer Action modules

| Standard | Interactive | Transactional | In-Store |
|---|---|---|---|
| Modules | Modules | Modules | Modules |
| External Web | Dialler | Purchases | Product |
| Link | | | Information |
| Video | Email Enquiry | Payments | Wish List |
| Mapping | Get App | Coupons | Loyalty |
| vCard | Competitions | Voting & Surveys | Warranty |
| Mobile Web Page | Reminder | | Wi-Fi Access |

The Standard modules primarily provide existing digital content. The Interactive modules generally involve the Customer volunteering their identity whilst benefiting from the functionality. The Transactional modules are all about purchases and or payments of products and services, whilst the In-Store modules combine all the other module types into an engaging and holistic in-store retail experience.

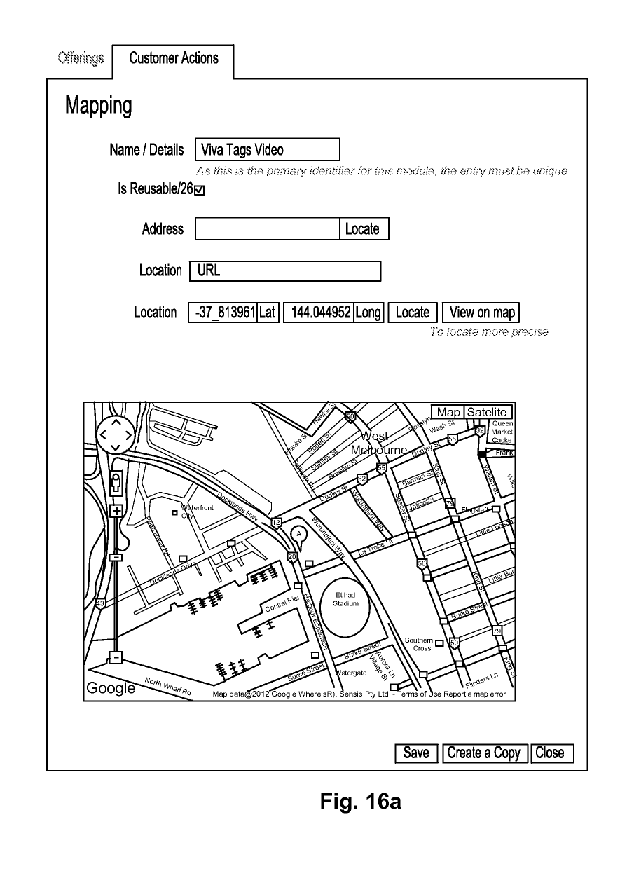

The Customer Actions list view illustrated in the screen shot of FIG. 14, has all the same sort, search 1410 and filter 1420 properties as our other list views, along with the line item displays for each existing Customer Action. Customer Actions can be created from within an Offering or by clicking the Create Customer Action button 1430 in the list view, following which vendors select the module type.

All Customer Actions have two common attributes. The first is a unique identifier Name/Details field which, like all other identifiers, don't appear to the Customer. The other is the “Is Reusable” checkbox 1450.

One of the key understandings for using Customer Actions is the difference between Single Use and Reusable Customer Action's. Single Use means they are either not intended to be, or not yet, associated with two or more Offerings. Ticking the “Is Reusable” checkbox within the Customer Action form, or by adding a Single Use Customer Action to a new Offering, makes that Customer Action Reusable. Any changes to Reusable Customer Action's will appear in all associated Offerings, hence they are typically used with organisational profiles such as a map to the vendor's showroom, or a key contact's vCard. Single Use Customer Action's are always unique to an Offering. By default, Single Use Customer Action's are hidden from list views, but can be included with the click of a button or checkbox 1450.

The following summarises the key attributes of the Standard and Interactive

Customer Action modules:

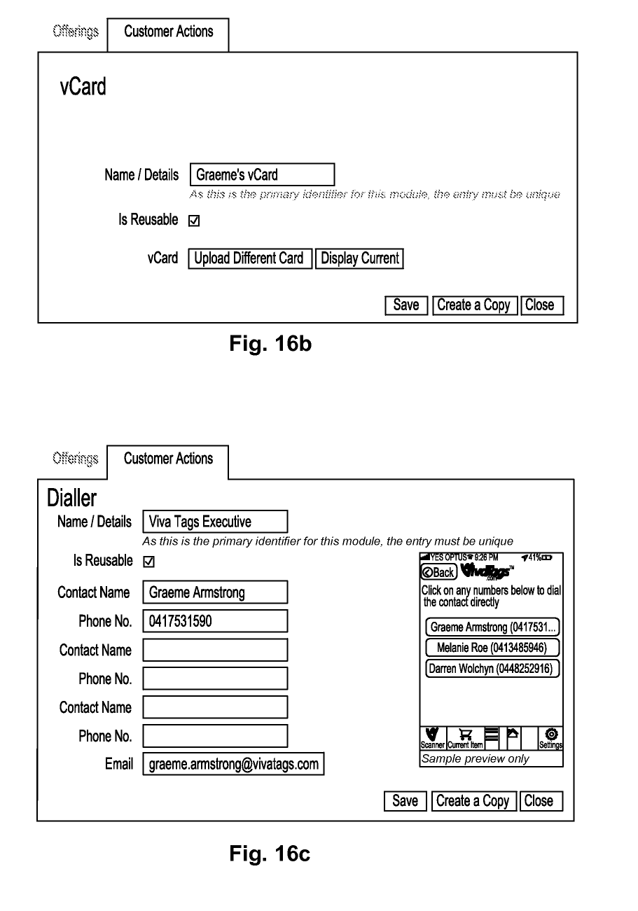

1. External Web Link (FIG. 15): The vendor adds any web page URL.

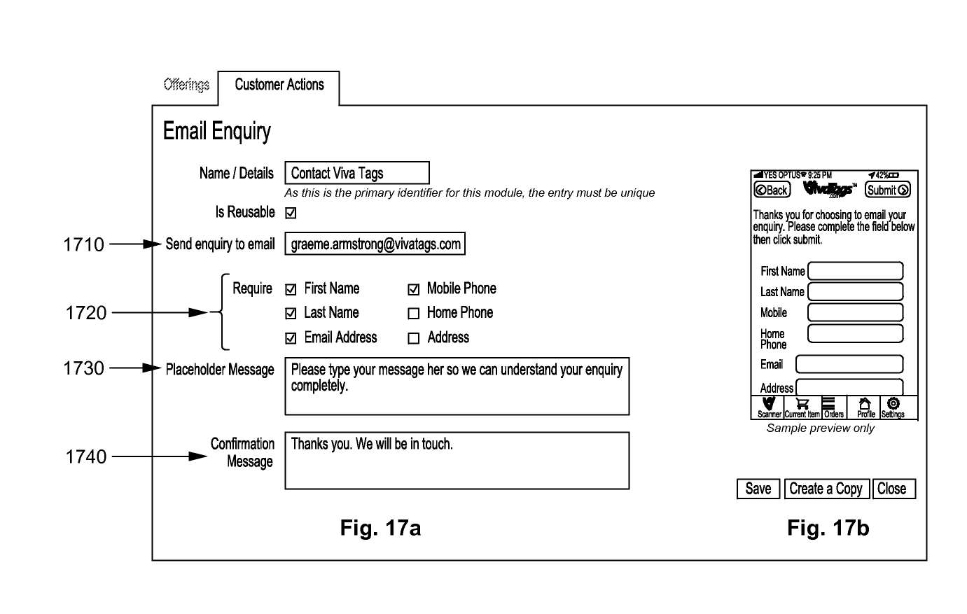

2. Video: To ensure a consistent and efficient video playback experience for Customers, Viva Tags has developed support for both the YouTube and Vimeo platforms. This may of course be extended as alternative platforms become available. FIG. 16 illustrates a screen shot of the Video webpage. The vendor chooses their platform host provider 1610 and the URL 1620 which needs to be recorded in the specified way, as per the instructional link provided.

3. Mapping (FIG. 16a): The vendor enters the address then clicks Locate. Upon confirmation of the correct pin drop, click Save.

4. vCard (FIG. 16b): The vendor first creates and saves the required vCard, then navigates to it after clicking the Browse button in the CA form.

5. Dialler (FIG. 16c): The vendor can add up to three names and numbers to each Dialler CA. The email addressee is immediately notified that someone has tried to call, and where that Customer is registered with the system, the message also identifies who they are. Vendors can also review Dialler contact details via their vendor web portal.

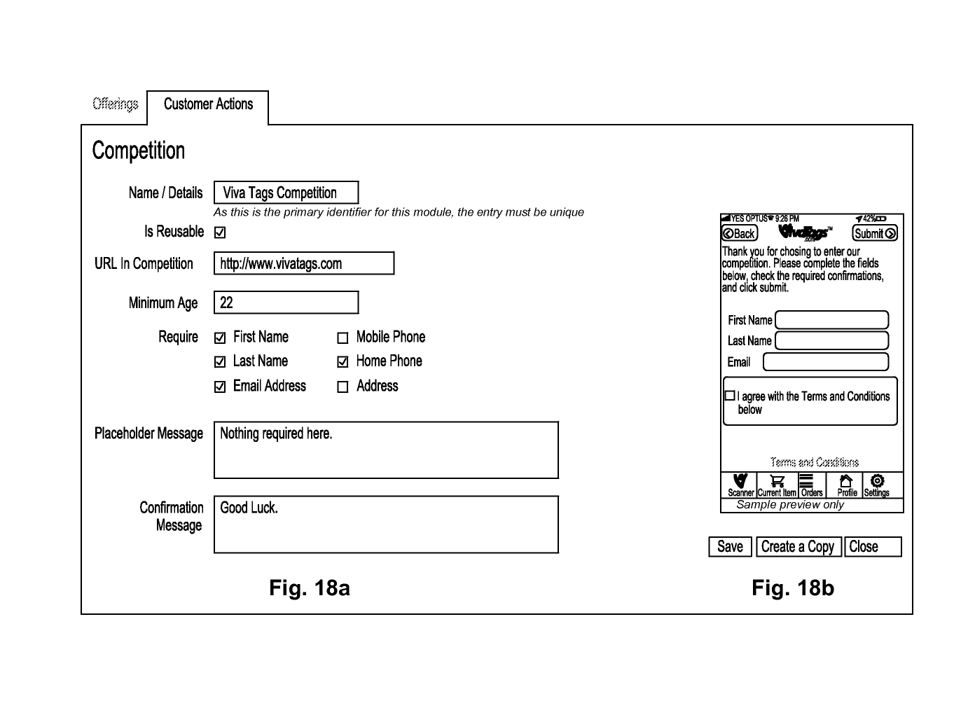

6. Email Enquiry: FIG. 17a illustrates a screen shot of the Email Enquiry webpage. The email addressee 1710 receives all enquiries, which can also be retrieved via the Vendor web portal. The vendor selects the fields 1720 which they require the Customer to complete as part of their email enquiry submission, and add any additional prompts to the Placeholder Message field 1730, which the Customer overtypes as part of their response. Finally the vendor adds a Confirmation Message to the Confirmation Message Field 1740 which the Customer receives after submitting their enquiry. FIG. 17b shows the resultant screen image that a Customer will see.

7. Competitions: Competitions are like Email Enquiries but have two additional fields to assist vendors comply with possible competition regulations. These include a URL link to the prevailing terms and conditions for the competition, as well as an age threshold which the Customer is required to confirm prior to submitting their entry.

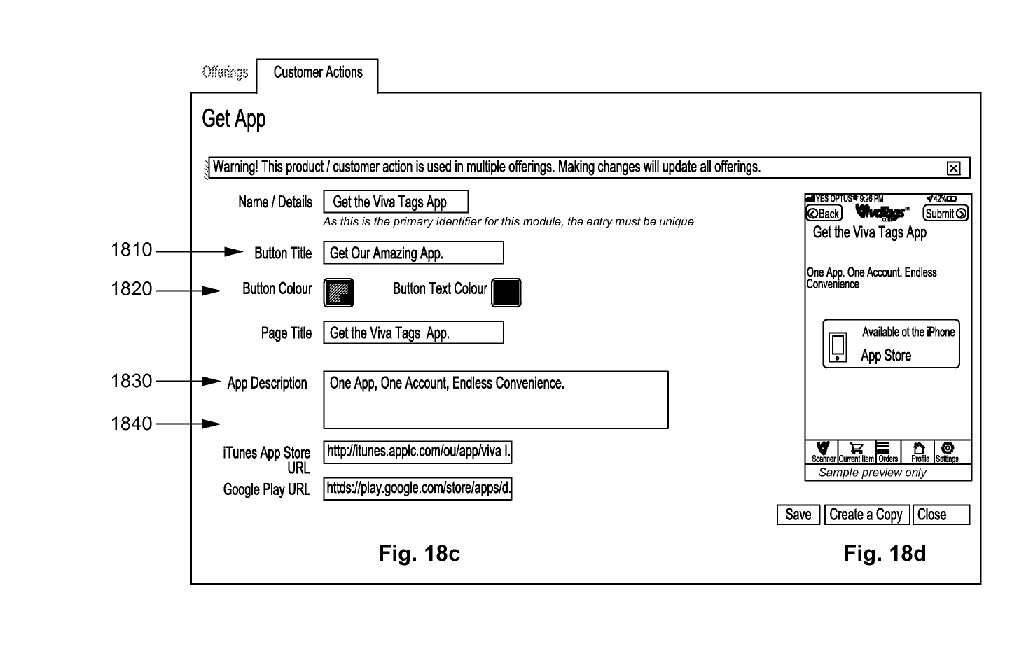

8. Get App: FIG. 18a illustrates a screen shot of the Get App webpage. The vendor enters data into the Page Title field 1810. The App Description field 1820 assists the Customer to understand the functionality of their App. The vendor then enters the correct URL's for the Apple App Store 1830 and or Google Play 1840. FIG. 18b shows the resultant screen image that a Customer will see.

### Vendor Portal-My Reports

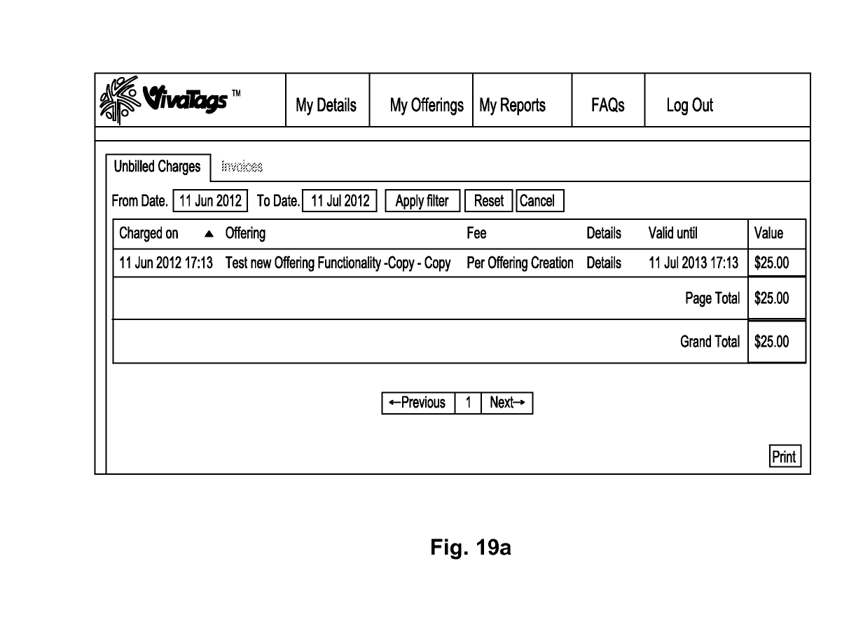

An Unbilled Charges tab (FIG. 19a) lists all Fees incurred that are yet to be invoiced. These can be filtered or exported to Excel for deeper analysis. An Invoices tab (FIG. 19b) shows all generated Tax Invoices, and the date they were paid where that has occurred. Clicking the “View” link (not shown) opens the Tax Invoice form which lists summary line items by Offering. This invoice form can also be printed for compliance purposes. The Export to Excel function delivers the line item detail for deeper analysis.

### Back Office-Vendor Invoicing

The Back Office Administrator is able to create a Tax Invoice for a vendor by clicking the “Unbilled Charges” button (not shown) against that vendor. Clicking this “Unbilled Charges” button brings up a webpage for that vendor as shown in FIG. 19c. The Back Office Administrator first creates any ad hoc charges or refunds for that vendor by clicking the “Ad Hoc Charge” button 1910 which opens up a separate webpage (not shown). When the Ad-hoc entries are complete, the Administrator selects and “Apply” the date range required, then click the “Start Invoicing” button 1920. Once satisfied the summary is correct, the Administrator creates an invoice. To proceed to charge the vendor's credit card, the Administrator confirms the summary page and click “Charge”. To leave the Invoice unpaid, click “Cancel”. Either way, the new invoice will now appear in the invoices section of the Back Office and the Vendor portal.

### Customers

Upon seeing a vendor's Smart Response Tag, supported by a clear call to action, the smartphone user consumers (otherwise referred to as Customers), have several options via which to engage. The first option is via third Party QR Code Scanner Software Applications or “Apps”.

With several million third Party scanner apps installed today, the platform has been developed so that most Customers using these Apps will experience most of the functionality of our vendor's offerings. This is despite the system having no direct control over the performance and presentation of these third Party Apps.

Supported functionality includes seeing all the display elements of the landing page as well as all the Customer Action buttons. With the exception of the vCards and Reminder functionality which have had to be disabled due to lack of technical control, all other Standard and Interactive Customer Actions should present correctly via third Party apps. However the navigation will be different to the Viva Tags app, and may vary between third Party Apps, and no auto completion of forms is possible.

For Transactional and In-Store Customer Actions, again functionality is limited, and no financial transactions are possible via third Party apps, as these require full identification of the Customer and security over the transaction. Wherever possible, Viva Tags offers an upgrade prompt or reminder to our own app, to assist the Customer understand that there is an easier way for them to get the most from our platform.

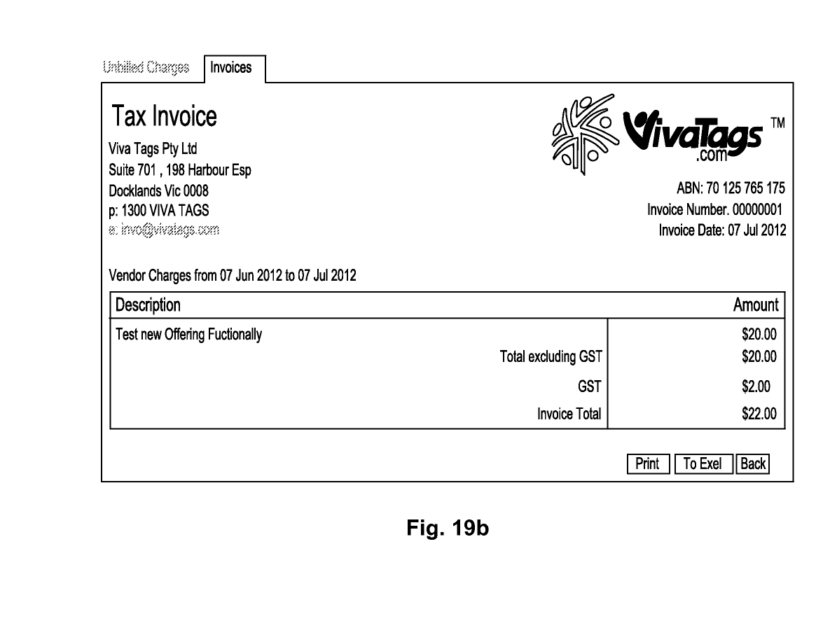

The second option is via the Viva Tags App, a screen shot of the Home page of which is shown in FIG. 20. The performance within the Viva Tags App differs depending on the Customer's log in state, which is managed from the Home page FIG. 20. If the Customer is not registered or not logged in, the Viva Tags App app behaves similarly to a third party app, although the vCards and Reminders are enabled and navigation is consistent. Most notably though, no transactions are possible if the Customer is not registered or logged in. Where the Customer is registered and logged in, the Viva Tags App provides the optimal Customer experience and all features of our platform are available.

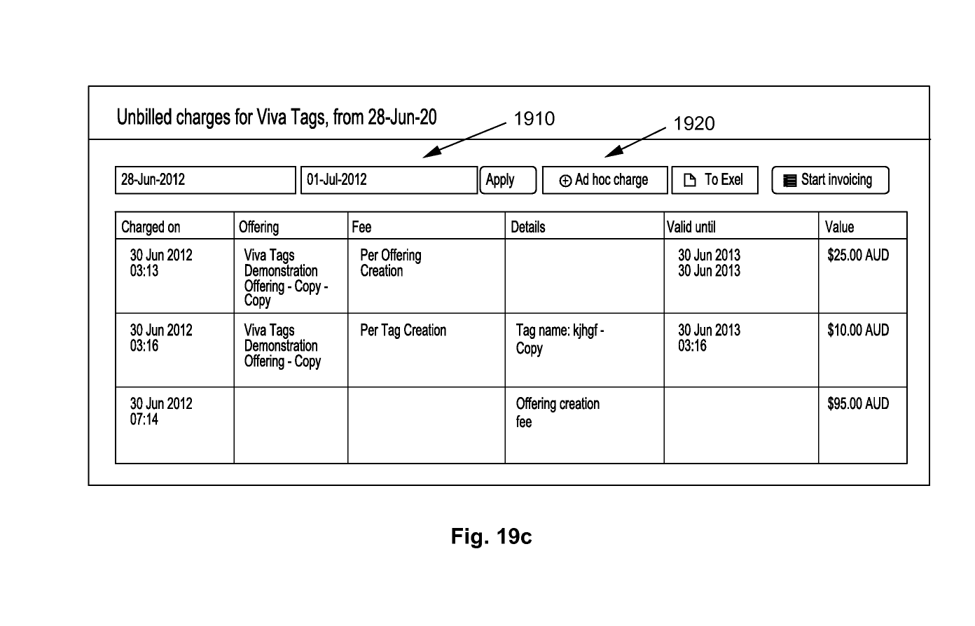

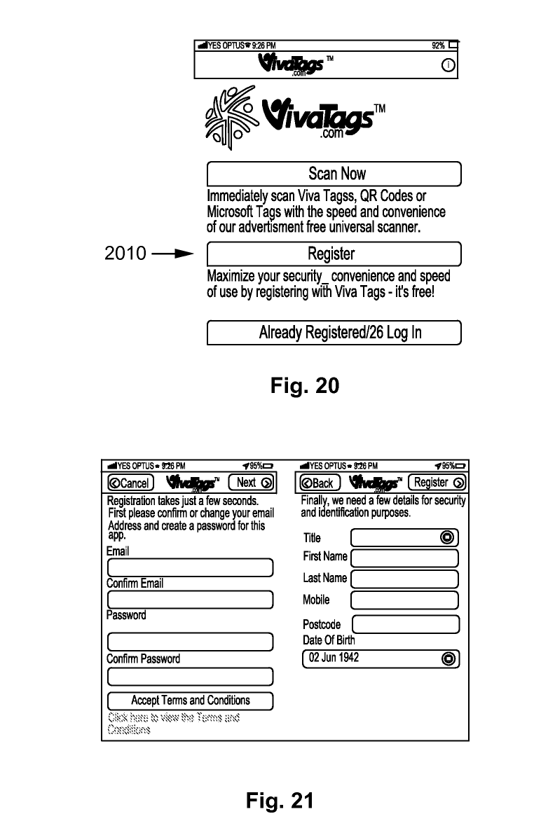

A Customer can register either by selecting the Register prompt 2010 on the Home page of the Viva Tags App which brings up a Registration page as shown in the screen shots illustrated in FIG. 21, or online via the links on the Viva Tags web site—see FIG. 22. As with vendor registration, Customers also receive a validation email, although this is automatically generated without Back Office involvement. Once the Customer clicks the validation link they have full access to their online vendor portal, prior to which they can only maintain their profile via the app.

### Customer Portal-Manage My Profile

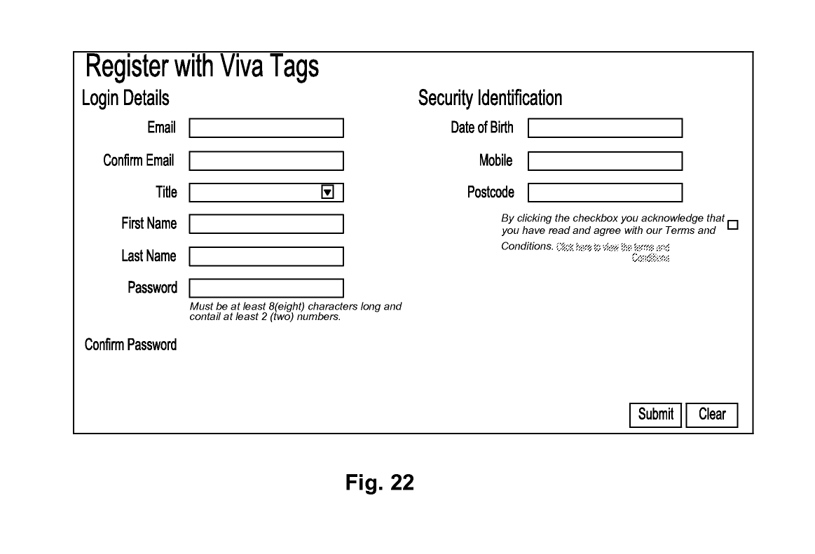

Once registration and validation is complete, Customer profile information can then be viewed and updated via the Viva Tags app profile tab (See FIG. 23) or by logging into the Customer portal and selecting My Details. Given most Customer enquiries and transactions will occur via the usability limitations of their smartphone, the system is designed to eliminate as many clicks or typing as possible. Therefore Viva Tags encourages all Customers to complete their profile information up front, including My Addresses 2310 for shipping and My Vehicle registration details 2320 for parking. However the system also allows for perpetual profiling as individual sessions occur should the Customer not complete their profile in advance.

The My Devices tab (not shown) automatically updates as different mobile devices access each Customer account, any of which can be deactivated and reactivated at the click of a button should the device be lost, stolen, or decommissioned. This section also provides controls over daily spending limits per device which makes Viva Tags an ideal and secure solution for parents providing their children with controllable and identifiable financial independence.

The My Tags tab 2330 is where Customers create and manage their Personal Tags. These can only be created via the Customer portal but are displayed in the Viva Tags app so all Viva Tags Customers can scan between their phones.

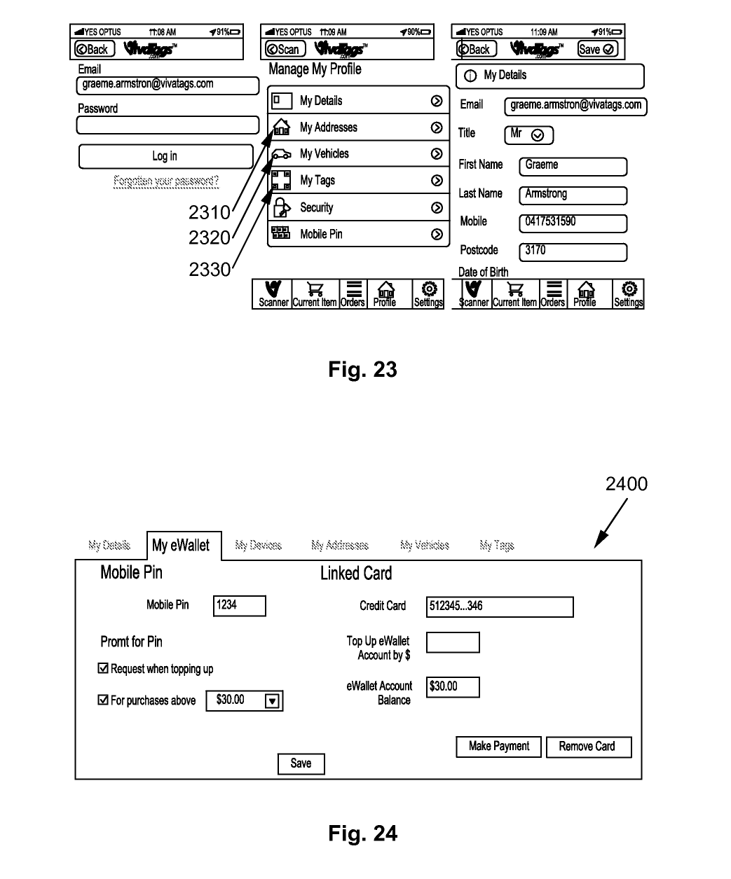

The My eWallet tab 2400 shown in the screen shot shown of FIG. 24, accesses the highly secure Customer payments management system. Viva Tags offers two types of payment options. The first is to directly charge the Customer's Credit or Debit card for purchases or payments. The card details can be entered by the Customer each time, or stored for one click completion of transactions. Stored card details are held securely by CBA BPOINT—Viva Tags does not store any card details, nor are card details are held on the Customer's smartphone. A $1 credit card surcharge does apply to direct card charges of less than $10 value. This is to cover merchant and payment gateway costs that we can't recoup from such small value transactions.

The second option is to create an eWallet, which is a dedicated Viva Tags debit account. Customers transfer funds from their stored Credit or Debit card into their eWallet, from which they can make subsequent purchases or payments of any value, without surcharges.

Built in system logic ultimately determines the most efficient means for settling larger transaction. Even with an eWallet set up, certain purchases or payment may still be charged directly to the Customer's stored card so as to avoid split or multiple transactions per settlement. The Customer is always advised which method is to be used in advance of processing any settlements.

Various security options are provided through the eWallet tab including a Mobile PIN entry required prior to processing all smartphone payments.

### Customer Portal-My Orders

This section contains a view of the Customer's transactions which can be filtered for easy analysis, including expense and tax refund purposes.

### Other

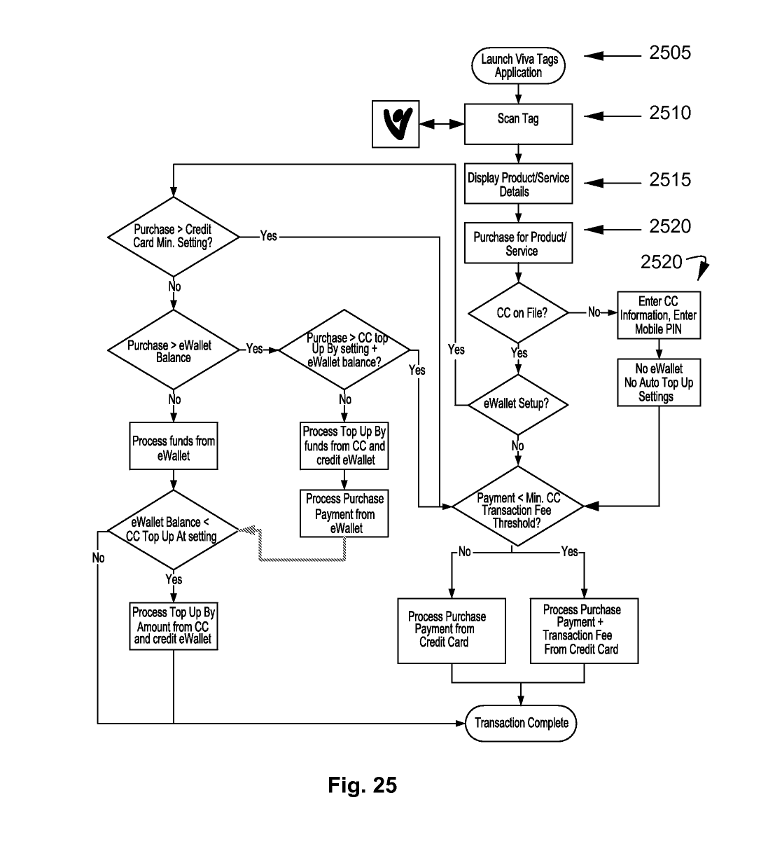

FIG. 25 illustrates the flow methodology for a customer to access a Tag using their mobile device. The customer launches the Viva Tag App, step 2505 and scans the desired tag, step 2510. In response to scanning the tag, details concerning the product or service is displayed, step 2515. The customer selects to purchase the product or service, step 2520 and the customer's details are checked to determine if the credit card is recorded on file. If the particular customer's credit card details are not recorded the customer is prompted to enter their credit card details, step 2525.

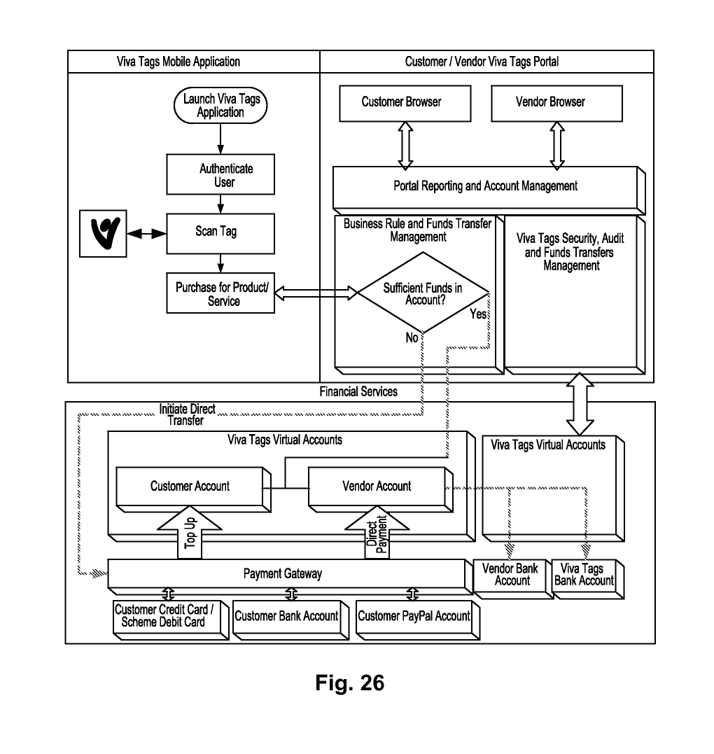

FIG. 26 illustrates a block diagram of the mobile e-commerce payment system architecture.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A vendor portal for electronic commerce over a network, the vendor portal comprising:
a vendor portal web site and a collection of preconfigured modules linked to the portal, and vendor tools to enable a vendor to compile a promotional offer or service by selecting and personalising one or more preconfigured modules; and
a unique identifier generator to generate and link a unique identifier to said promotional offer or service; wherein the portal is operable to cause the vendor compiled promotional offer or service to be displayed on a user interface of a customer's networked device when a customer uses their networked device to scan said unique identifier.

2. The vendor portal for electronic commerce over a network according to claim 1, wherein the vendor portal is further operable to cause each of the selected preconfigured modules to appear on the user interface as discrete items.

3. The vendor portal for electronic commerce over a network according to claim 2, wherein the vendor tools further enable a vendor to selectively compile a single function promotional offering or service or a multi-function promotional offering and/or service.

4. The vendor portal for electronic commerce over a network according to claim 3, wherein the vendor tools further enable a vendor to generate and associate a landing page with a multi-function promotional offering and/or service.

5. The vendor portal for electronic commerce over a network according to claim 4, wherein the generated landing page is configured to display at least a header associated with each of the selected and personalised preconfigured modules.

6. The vendor portal for electronic commerce over a network according to claim 1, wherein the vendor portal web site includes a registration webpage to enable vendors to register with the vendor portal.

7. The vendor portal for electronic commerce over a network according to claim 1, wherein the preconfigured modules include one or more of content modules, lead generation modules, custom modules, transactions, in-store modules and associated products.

8. The vendor portal for electronic commerce over a network according to claim 7, wherein content modules include one or more of external web links, play video, maps, get software application and Mobile Web Pages; interactive modules include one or more of dialler, emails, competitions, check in/opt in, reminders, and vCards; transactions include one or more of purchases, payments, timesheets, voting and coupons; and in-store modules include one or more of product info, a wish list, a loyalty, warranty and WiFi access.

9. A method for facilitating electronic commerce over a network, the method comprising:
compiling a promotional offer or service by selecting one or more preconfigured modules to be associated with the promotional offer or service;
generating a unique data identifier and linking the unique data identifier to the promotional offer or service; and
causing the compiled promotional offer or service to be displayed on a user interface of a customer's networked device when a customer uses their networked device to scan the unique data identifier, wherein each of the selected preconfigured modules appear on the user interface of the customer's device as discrete items.

10. The method for facilitating electronic commerce over a network according to claim 9, further comprising selectively compiling a single function promotional offering or service or a multi-function promotional offering and/or service.

11. The method for facilitating electronic commerce over a network according to claim 10, further comprising generating a landing page to be associated with a multi-function promotional offering and/or service.

12. The method for facilitating electronic commerce over a network according to claim 11, further comprising configuring the landing page to initially display on a user interface of a customer's device when the customer uses their networked device to scan the unique data identifier, the landing page comprising a header associated with each of the selected and personalised preconfigured modules.

13. The method for facilitating electronic commerce over a network according to claim 12, further comprising defining at least one of visual and functional elements that will appear on the landing page.

14. The method for facilitating electronic commerce over a network according to claim 9, further comprising defining an effective start date which determines when the promotional offering or service will present fully when a customer uses their networked device to scan the unique identifier and an effective end date which determines when the promotional offering or service is to expire.
